(19) United States
(12) Patent Application Publication
(10) Pub. No.: US 2014/0344431 A1
(43) Pub. Date: Nov. 20, 2014

(54) BASEBOARD MANAGEMENT SYSTEM ARCHITECTURE

(71) Applicant: ASPEED Technology Inc., Hsinchu City (TW)

(72) Inventors: FU-CHOU HSU, Hsinchu City (TW); HUNG-JU HUANG, Hsinchu City (TW); Chung-Yen LU, Hsinchu City (TW)

(73) Assignee: ASPEED Technology Inc., Hsinchu City (TW)

(21) Appl. No.: 13/895,905

(22) Filed: May 16, 2013

(51) Int. Cl. H04L 12/24

(52) U.S. Cl. CPC H04L 41/24
USPC 709/223

(57) ABSTRACT

A baseboard management system suitable for use in a high density server system is provided. The baseboard management system comprises: a plurality of baseboard management controller (BMC) node respectively located on the servers; and, a main BMC coupled to a network and to the BMC nodes through a communication link for executing a management software; wherein each BMC node is connected with a corresponding host processor and with server board peripherals individually on a corresponding server; and wherein the main BMC in cooperation with the BMC nodes is used to manage the servers remotely.

### BACKGROUND OF THE INVENTION

1. Field of the Invention

The invention relates to baseboard management controllers (BMC), and more particularly, to a baseboard management system.

2. Description of the Related Art

A server is a physical computer system, dedicated to running one or more services and to serving the needs of the users of other computers on a network. A BMC is a management controller in a server computer to manage and monitor the server operations and health. The BMC includes major management functions as follows.

1. Intelligent Platform Management Interface (IPMI): IPMI is an industry standard for system monitoring and event recovery. The IPMI specification defines a common message-based interface for accessing all of the manageable features in a server. IPMI includes a rich set of predefined commands for reading temperature, voltage, fan speed, chassis intrusion, and other parameters. System event logs, hardware watchdogs, and power control can also be accessed through IPMI. In this manner, IPMI defines protocols for accessing the various parameters collected by a BMC through an operating system or through an external connection, such as through a network or a serial connection. A server host transfers IPMI messages to a BMC through Low Pin Count (LPC) bus, and some device channels are created on the LPC bus for this purpose, such as Keyboard Controller Style (KCS) interface and Block Transfer (BT) interface.

2. Server board environment status monitoring (such as temperature, voltage, fan speed), host operating status monitoring (such as host power state) and motherboard working maintenance: If any invalid state occurs in the system, such as a high temperature or a power failure, the BMC can try to recover the abnormal conditions and issue alert to the manager through the network.

3. SuperIO function: SuperIO is a device attached on the LPC bus. It supports multiple IO devices for the system, such as host serial COM port, 80H/81H port monitoring, ACPI (Advanced Configuration and Power Interface) and system power management.

4. Serial over LAN (SOL): SOL is a Host message collecting interface similar to the IPMI. The host side software can output messages to the serial COM port, and the BMC can collect and store the messages received from the COM port into storage media of the BMC and transmit to the client side computer on the network. The messages can help the management engineers to debug current operating conditions of the system.

5. System Basic Input/Output System (BIOS) maintenance: BMC can update the system BIOS and reboot the host system.

6. Video Graphics Adapter (VGA): The VGA function is embedded in the BMC for Host display output.

7. Remote management: Remote management is an important capability of the BMC. It is often necessary to manage the operations of a server computer, such as getting information regarding the relative health of a server computer. For many conventional systems, the technician that needs to view the screen display and interact with the server being managed is required to be physically located at the site of the server. However, it is not always feasible for a technician to be physically present at the location of the server computer.

For example, a system administrator of a corporate network may be present at one location while the servers may be spread around the buildings or even anywhere of the internet. To effectively manage the servers on the corporate network, the system administrator must be able to monitor each of the server computers, regardless of their location. It is very difficult and costly for the system administrator to be physically present at each server side of managed.

Under this circumstance, the remote management function supported by the BMC can help the system administrator to be able to access server information on his own computer (client) through the network, just like physically present at the server side. The BMC can support remote management interface for IPMI, SOL, system and sensor status reading, power control, and BIOS maintenance. The BMC also can redirect the video output from the server computer to a remote location and allow keyboard and mouse input to be provided to the server from the remote location. The BMC also can redirect a storage device located at a remote computer to be provided to the server as an USB (Universal Serial Bus) storage device.

FIG. 1 is a block diagram showing a server including a BMC according to prior arts. A BMC 120 on a server 100 supports many Input/Output interfaces for management purpose. PCIe (Peripheral Component Interconnect Express) interface supports the VGA function and the source for video redirection. LPC interface supports IPMI, SuperIO, and SOL functions. USB interface supports storage, keyboard and mouse redirection. A SMBus (System Management Bus) supports sensors (112) reading and IPMI communication.

PWM (pulse width modulation) and Tachometer interfaces support chassis fan speed control and monitoring. A GPIO (General Purpose Input/Output) interface supports main-board event control and monitoring. The path (e.g., Serial Peripheral Interface Bus) connected to a BIOS flash 115 is for BIOS maintenance. The following three connectors support external connections: VGA connector 132 is for display output and connected to a monitor; LAN connector 130 is a network port for remote management; COM port 136 is a serial interface of the server 100.

A traditional BMC is designed to only support one server (or one host) in a server system. A server includes one, two or more processors linked together with dedicated DRAM DIMMs and common I/O interfaces, running a single operating system (OS). FIG. 2 illustrates a conventional baseboard management system in a network environment. Referring to FIG. 2, a conventional baseboard management system 200 includes a plurality of BMCs 120 respectively located on the servers 100. That is, each server 100 includes a BMC 120 for management control and each BMC 120 has a network port 130 connected to a network tree 210 of a company or the global world. A client computer 180 located anywhere in the network tree 210 can remotely access any BMC 120 of a server 100 in the same network tree 210. By accessing the BMC 120, a manager can take control of the server host 100 and monitor the environment status that is supported by the BMC 120.

Different application fields require different server design styles. For data communication field, it requires highly parallel computing effort. Thus, a high density of processors running dedicated OS is the target. Since the number of servers grows high (up to tens) in a high density server system, it is not suitable to use a complex BMC design for each server. Meanwhile, a main constraint of a high density server system is a limited board space. Thus, the high density server system needs simpler design, lower power and lower cost. In view of a maximum number of processors in a limited board space, a limited power budget and a limited cost, a simplified design of a baseboard management system suitable for use in a high density server system is needed.

### SUMMARY OF THE INVENTION

In view of the above-mentioned problems, an object of the invention is to provide a baseboard management system to simplify BMC functions on server boards and to increase the density of a server system.

One embodiment of the invention provides a baseboard management system suitable for use in a high density server system having a plurality of servers. The baseboard management system comprises: a plurality of baseboard management controller (BMC) nodes respectively located on the servers; and, a main BMC coupled to a network and to the BMC nodes through a communication link for executing a management software; wherein each BMC node is connected with a corresponding host processor and with server board peripherals individually on a corresponding server; and wherein the main BMC in cooperation with the BMC nodes is used to manage the servers remotely.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing a server including a BMC according to prior arts.

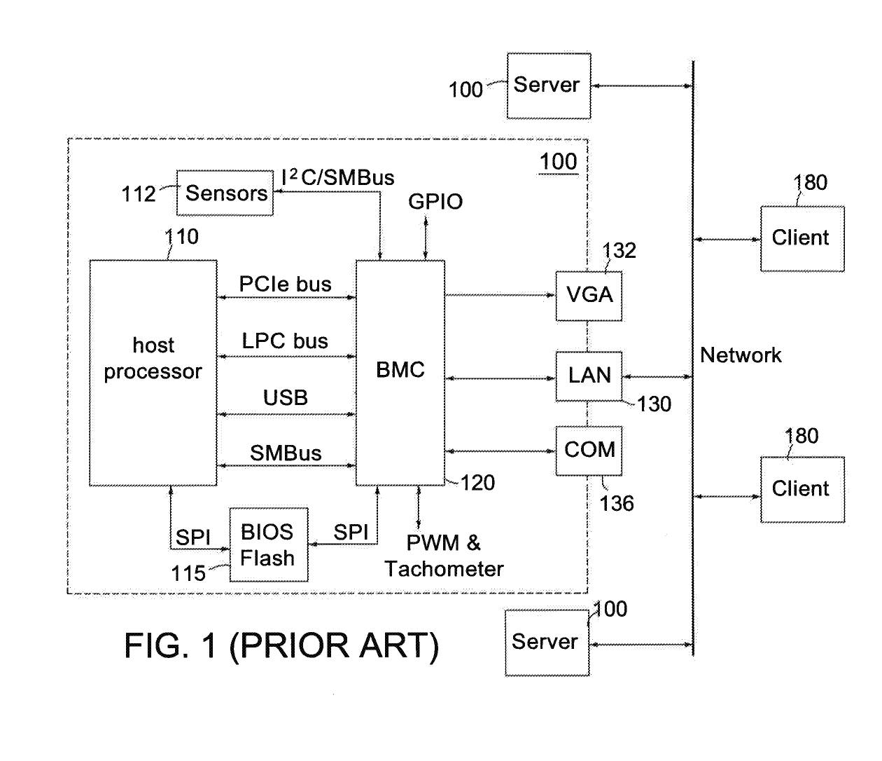

FIG. 2 illustrates a conventional baseboard management system in a network environment.

FIG. 3 is a block diagram showing a baseboard management system according to one embodiment of this invention.

FIG. 4A is a block diagram showing a BMC node according to one embodiment of this invention.

FIG. 4B is a block diagram showing a main BMC according to one embodiment of this invention.

FIG. 5 is a block diagram showing a baseboard management system using a USB connection according to another embodiment of this invention.

FIG. 6 is an exemplary diagram showing a software architecture utilized on a BMC node, a serial communication link and a main BMC for system management according to another embodiment of the invention.

### DETAILED DESCRIPTION OF THE INVENTION

As used herein and in the claims, the term “a,” “an,” “the” and similar terms used in the context of the present invention (especially in the context of the claims) are to be construed to cover both the singular and plural unless otherwise indicated herein or clearly contradicted by the context. Besides, the term “chassis board” refers to a management function board that is designed for management purpose only for all server boards located in the same mechanical case or chassis, and that manages the power supplies, fans, and all the environment conditions in the case or chassis. Further, the chassis board can communicate with each server board and collect information for management purpose.

A feature of the invention is to simplify BMC functions on server boards and to increase the density of a server system. Another feature of the invention is to move a part of BMC functions, such as user interfaces, from server boards to chassis boards. Accordingly, a baseboard management system of the invention is split into two sections, one on the server side and the other on the main baseboard management controller side.

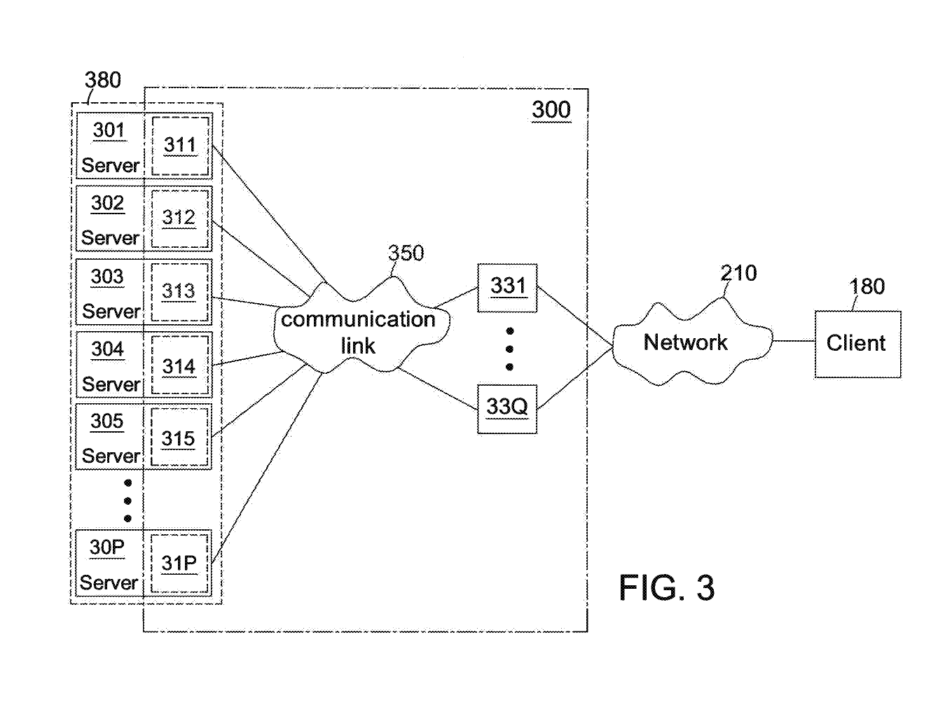

FIG. 3 is a block diagram showing a baseboard management system according to one embodiment of this invention. A baseboard management system 300 of the invention is suitable for use in a high density server system 380. The baseboard management system 300 includes a plurality of BMC nodes 311˜31P (on respective server boards) and at least one main BMC 331—33Q (on respective chassis boards), where P>>Q and Q>=1. The at least one main BMC 331˜33Q is separate from the servers 301˜30P. The BMC nodes 311˜31P are coupled to the at least one main BMC 331˜33Q through a communication link 350. The server system 380 includes a plurality of servers 301˜30P, each having a corresponding BMC node resident on its corresponding server board (not shown). In other words, the BMC nodes 311˜31P are respectively located in the servers 301˜30P and used to monitor and control the servers 301˜30P remotely. The BMC nodes 311˜31P are substantially identical while the main BMC 331˜33Q are substantially identical. The number of the BMC nodes (311˜31P) is scalable so that many BMC nodes can be linked to a main BMC through the communication link 350. In fact, the number of the BMC nodes 311˜31P varies according to the performance of the main BMCs (331˜33Q).

A main BMC (331˜33Q) can be connected to multiple BMC nodes (311˜31P) concurrently and performs management operations on the servers (301˜30P) respectively including the multiple BMC nodes. A user located at the client computer 180 may remotely manage the operations of a managed server of the server system 380 via the network 210, a corresponding main BMC (331˜33Q) and a corresponding BMC node (311˜31P). It should be appreciated that the client computer 180 can perform the same management operations on the BMC nodes 311˜31P and the main BMCs 331˜33Q as well as on the traditional BMCs. The network 210 may be of various forms such as a local area network (LAN) or wide area network (WAN) including the internet. The servers (301˜30P) and the client computer 180 may include standard desktop computers.

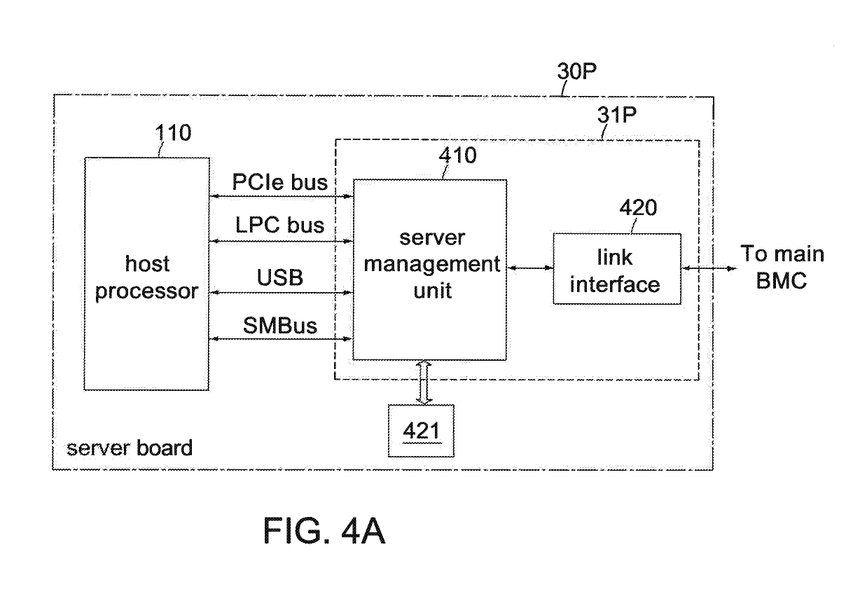

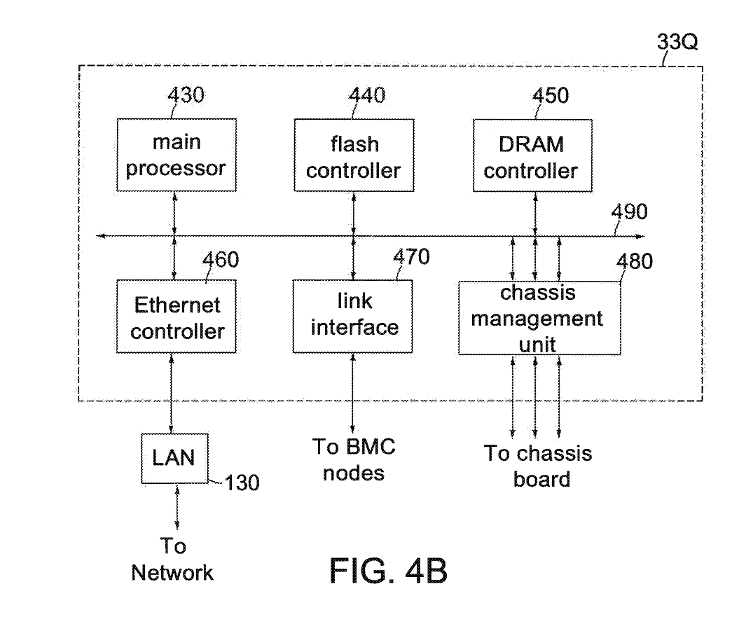

FIG. 4A is a block diagram showing a BMC node 31P according to one embodiment of this invention. The BMC node 31P includes a server management unit 410 and a link interface 420. The server management unit 410 enables communication and exchanges management information between the BMC node 31P and the server 30P (including the host processor 110 and a plurality of server board peripherals 421). The server management unit 410 supports management interfaces for server board control and montoring in the server 30P. The server management unit 410 may include input/output interfaces for connection to the host processor 110 and to the server board peripherals 421. For instance, the server management unit 410 may include an USB controller for connecting to the host processor 110 via an USB link. It should be appreciated that other types of links may be utilized for enabling communication between the BMC node 31P and the server 30P, such as PCIe, LPC, SMBus, USB, GPIO, and others. The link interface 420 is used to establish a communication link with its corresponding main BMC. Depending on what functions/information need to be managed or collected in the server 30P, the BMC node 31P may optionally include other components, such as a microprocessor, a flash controller or a SRAM device.

FIG. 4B is a block diagram showing a main BMC 33Q according to one embodiment of this invention. The main BMC 33Q on a chassis board includes a main processor 430, a flash controller 440, a DRAM controller 450, an Ethernet controller 460, a link interface 470 and a chassis management unit 480. The six components 430˜480 are coupled to each other through an internal bus 490. The main processor 430 executes related software and firmware for management control and event logging. The flash controller 440 and the DRAM controller 450 are used to control accesses of program codes and data in flash memories and DRAM devices (not shown) on the chassis board. The Ethernet controller 460 supports a network link through a LAN port 130 to the network 210 for remote management. The link interface 470 is used to establish a communication link with its corresponding BMC nodes. The chassis management unit 480 performs management operations on the chassis board by gathering information through specified interfaces. Example management operations include, without limitation, IPMI, event logging, VGA display, fan speed control, sensor readings, analog to digital conversion, and timers. Example specified interfaces includes, without limitation, Inter-Integrated Circuit (I²C), UART (an abbreviation for “Universal Asynchronous Receiver/Transmitter”), SMBus, USB, and GPIO.

Referring back to FIG. 3, the communication link 350 is a parallel communication link or a serial communication link. In one embodiment, the communication link 350 has a hot plugging capability; accordingly, another BMC node located at another server is allowed to be dynamically added into the baseboard management system 300 through the communication link 350 without rebooting the baseboard management system 300. In alternative embodiment, the communication link 350 between the BMC nodes and the main BMC is a serial communication link supporting a high bandwidth transmission, minimum physical connection wires, hot plugging and a long transmission distance. The BMC software executing on the main BMCs 331˜33Q can access each BMC node through the serial communication link for system management. Depending on what type of serial communication link interface is used, the communication protocol on the serial communication link can be privately defined or conform to an industrial standard to reach the original BMC management purpose. Example serial communication links include, without limitation, USB, PCIe, LAN and Optical Fiber.

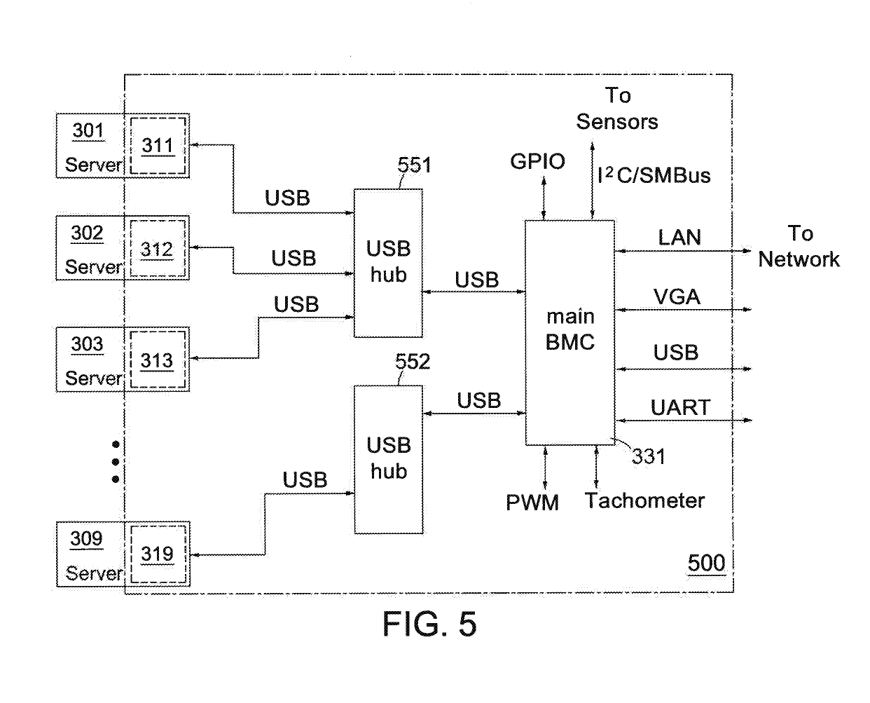

FIG. 5 is a block diagram showing a baseboard management system using a USB connection according to another embodiment of this invention. In this embodiment of FIGS. 5, P=9 and Q=1. The communication link between the BMC nodes 311˜319 and the main BMC 331 is a USB connection. The USB connection includes two USB hubs 511 and 512. As known to those skilled in the art, a USB hub is used to expand a single USB port into several USB ports so that multiple BMC nodes can be coupled to the main BMC 331 through the USB hubs 511 and 512. The

USB connection can develop a communication over a 5-meter cable and support hot plugging.

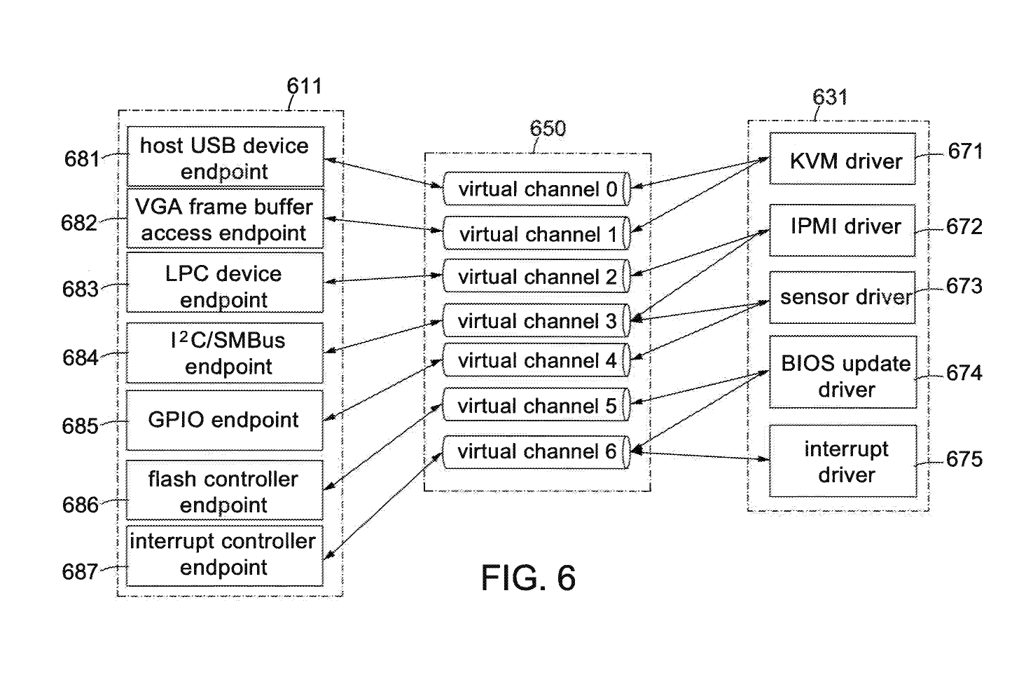

FIG. 6 is an exemplary diagram showing a software architecture utilized on a BMC node, a serial communication link and a main BMC for system management according to another embodiment of the invention. According to an embodiment of FIG. 6, a firmware executing on the main BMC 631 includes a KVM (an abbreviation for “keyboard, video and mouse”) driver 671, a IPMI driver 672, a sensor driver 673, a BIOS update driver 674 and an interrupt driver 675. Although a serial communication link 650 physically includes a small number of signal wires (such as two signal wires for an USB connection), it can be divided into up to seven virtual channels 0˜6, each having its own specified communication protocol. A total of seven items/devices in the BMC node 611 need to be monitored or controlled, so there are seven endpoints 681˜687 formed on the BMC node side. Assuming that the main BMC 631 is coupled to ten BMC nodes including the BMC node 611 through the serial communication link 650. Each firmware driver operating in the main BMC 631 can manage a corresponding device in each of the ten BMC nodes through a dedicated virtual channel and endpoint transmission path. For example, the interrupt driver 675 constantly monitors the interrupt controllers of the ten BMC nodes through the virtual channel 6 and the interrupt controller endpoints 687; the BIOS update driver 674 controls the flash controllers of the ten BMC nodes through the virtual channel 5 and the flash controller endpoints 686. It should be appreciated that the software architecture of FIG. 6 is provided by way of example and not limitation of the invention.

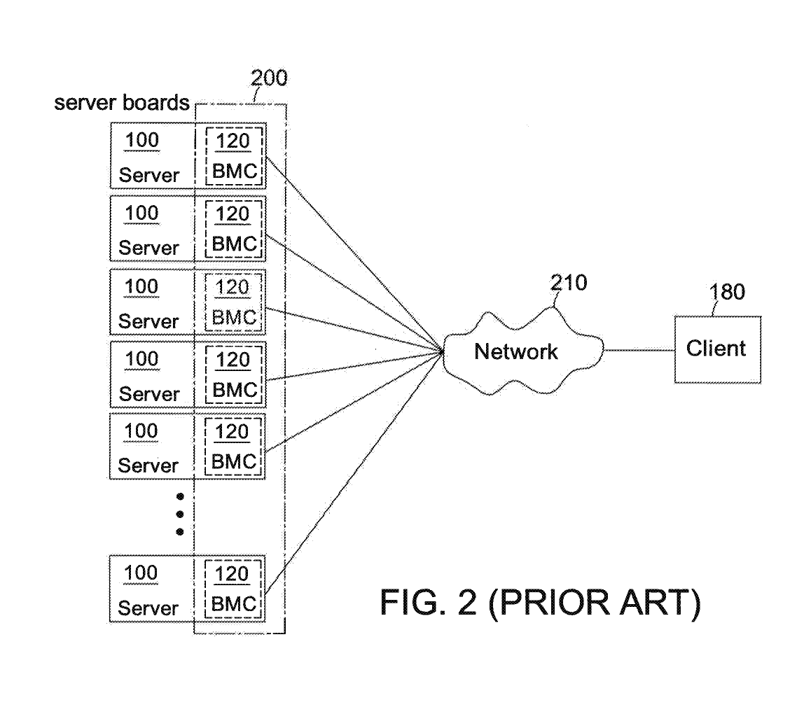

In comparison with the conventional baseboard management system in FIG. 2, the baseboard management system 300 of the invention has advantages as follows. (1) Simpler server board design: It operates with lower-end BMC node chips; (2) lower power consumption and smaller PCB board space for each BMC node on a server board; (3) less number of network ports: the number of network ports 130 is reduced to Q in the baseboard management system 300 in contrast to the fact that a network port 130 is required for each server 100 in the conventional baseboard management system of FIG. 2; (4) lower cost: It supports more hosts (servers) with lower cost.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A baseboard management system applied in a server system having a plurality of servers, comprising:
a plurality of baseboard management controller (BMC) nodes respectively located on the servers; and
a main BMC coupled to a network and to the BMC nodes through a communication link for executing a management software;
wherein each BMC node is connected with a corresponding host processor and with server board peripherals individually on a corresponding server; and
wherein the main BMC in cooperation with the BMC nodes is used to manage the servers remotely.

2. The system according to claim 1, wherein the communication link is a serial communication link.

3. The system according to claim 2, wherein the serial communication link is one of an USB connection, a PCIe connection, a LAN connection, an Optical Fiber connection and a privately defined connection.

4. The system according to claim 1, which allows another BMC node located at another server to be dynamically added through the communication link without rebooting the baseboard management system when the communication link has a hot-plugging capability.

5. The system according to claim 1, wherein each BMC node comprises:
a server management unit for enabling communication and exchanging information with the corresponding host processor and the server board peripherals on a corresponding server; and
a first link interface coupled to the server management unit for establishing the communication link with the main BMC.

6. The system according to claim 1, wherein the main BMC comprises:
a main processor;
a flash controller;
a DRAM controller;
a network controller for communicating with the network through a network port; and
a second link interface for establishing the communication link with the BMC nodes;
wherein the main processor, the flash controller, the DRAM controller, the network controller, and the second link interface are coupled to each other.

7. The system according to claim 6, wherein the main BMC further comprises:
a chassis management unit for performing management operations on a chassis board by gathering information through specified interfaces;
wherein the main processor, the flash controller, the DRAM controller, the network controller, the second link interface and the chassis management unit are coupled to each other.
